(19) United States
(12) Patent Application Publication
(10) Pub. No.: US 2025/0245289 A1
(43) Pub. Date: Jul. 31, 2025

(54) METHOD AND ELECTRONIC APPARATUS FOR COMPUTATION ON TRANSFORMER-BASED NEURAL NETWORK

(71) Applicant: Novatek Microelectronics Corp., Hsinchu (TW)

(72) Inventor: Ting-Yang Chen, New Taipei City (TW)

(73) Assignee: Novatek Microelectronics Corp., Hsinchu (TW)

(21) Appl. No.: 18/964,667

(22) Filed: Dec. 1, 2024

Related U.S. Application Data
(60) Provisional application No. 63/625,298, filed on Jan. 26, 2024.

(51) Int. Cl. G06F 17/16; G06F 7/78

(52) U.S. Cl. CPC G06F 17/16; G06F 7/78

(57) ABSTRACT

A method and an electronic apparatus for computation on an attention layer of a transformer-based neural network are proposed. The method includes to receive a query input, a key input, and a value input from a previous layer of the attention layer, to obtain a first merged weight which is pre-computed based on a weight matrix for queries and a weight matrix for keys, to obtain a second merged weight which is pre-computed based on a weight matrix for values and a weight matrix for output scores, and to perform computation based on the query input, the key input, the value input, the first merged weight, and the second merged weight to generate an attention score of the attention layer.

### CROSS-REFERENCE TO RELATED APPLICATION

This application claims the priority benefit of U.S. Provisional application Ser. No. 63/625,298, filed on Jan. 26, 2024. The entirety of the above-mentioned patent application is hereby incorporated by reference herein and made a part of this specification.

### TECHNICAL FIELD

The disclosure relates to a method and an electronic apparatus for computation on a transformer-based neural network.

### BACKGROUND

The transformer is a deep learning architecture that has revolutionized natural language processing and has achieved state-of-art results in various tasks. The attention mechanism is one of the core components of the transformer, which allows the deep learning model to focus on relevant parts of input data. In the standard transformer, an attention weight is computed by a dot product of a weighted query input and a weighted key input followed by a scale operation and a softmax function, and an attention score is computed by a matrix multiplication of the attention weight and a weighted value input followed by a weight operation. However, high computational burden and memory access amount of such architecture make its real-time application on resource-constrained devices challenging.

### SUMMARY OF THE DISCLOSURE

A method and an electronic apparatus for computation on a transformer-based neural network on an attention layer of a transformer-based neural network are proposed.

According to one of the exemplary embodiments, the method includes to receive a query input, a key input, and a value input from a previous layer of the attention layer, to obtain a first merged weight which is pre-computed based on a weight matrix for queries and a weight matrix for keys, to obtain a second merged weight which is pre-computed based on a weight matrix for values and a weight matrix for output scores, and to perform computation based on the query input, the key input, the value input, the first merged weight, and the second merged weight to generate an attention score of the attention layer.

According to one of the exemplary embodiments, the electronic apparatus includes a processor configured to receive a query input, a key input, and a value input from a previous layer of the attention layer, to obtain a first merged weight which is pre-computed based on a weight matrix for queries and a weight matrix for keys, to obtain a second merged weight which is pre-computed based on a weight matrix for values and a weight matrix for output scores, and to perform computation based on the query input, the key input, the value input, the first merged weight, and the second merged weight to generate an attention score of the attention layer.

A method and an electronic apparatus for computation across an attention layer and a multilayer perceptron (MLP) layer of a transformer-based neural network are proposed.

According to one of the exemplary embodiments, the method includes to receive a residue and an attention matrix of the attention layer, to obtain a first low-rank weight matrix for output scores and a second low-rank weight matrix for output scores produced by a low-rank decomposition of a weight matrix for output scores as well as a third merged weight, and to perform computation based on the residue, the attention matrix, the first low-rank weight matrix for output scores, and the third merged weight to accordingly generate an output of a designated path of the MLP layer, where the third merged weight is pre-computed based on the second low-rank weight matrix for output scores and a weight matrix of the MLP layer.

According to one of the exemplary embodiments, the electronic apparatus includes a processor configured to receive a residue and an attention matrix of the attention layer, to obtain a first low-rank weight matrix for output scores and a second low-rank weight matrix for output scores produced by a low-rank decomposition of a weight matrix for output scores as well as a third merged weight, and to perform computation based on the residue, the attention matrix, the first low-rank weight matrix for output scores, and the third merged weight to accordingly generate an output of a designated path of the MLP layer, where the third merged weight is pre-computed based on the second low-rank weight matrix for output scores and a weight matrix of the MLP layer.

It should be understood, however, that this summary may not contain all of the aspect and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a schematic diagram of an electronic apparatus in accordance with an exemplary embodiment of the disclosure.

FIG. 2 illustrates a flowchart of a method for computation on an attention layer of a transformer-based neural network in accordance with an exemplary embodiment of the disclosure.

FIG. 3 illustrates a schematic diagram of a method for computation on an attention layer of a standard transformer-based neural network in the existing art.

FIG. 4 illustrates a schematic diagram of a method for computation on an attention layer of a transformer-based neural network in accordance with an exemplary embodiment of the disclosure.

FIG. 5 illustrates a flowchart of a method for computation across an attention layer and a MLP layer of a transformer-based neural network in accordance with an exemplary embodiment of the disclosure.

FIG. 6 illustrates a schematic diagram of a method for computation across an attention layer and an MLP layer of a standard transformer-based neural network in the existing art.

FIG. 7 illustrates a schematic diagram of a method for computation across an attention layer and an MLP layer of a transformer-based neural network in accordance with an exemplary embodiment of the disclosure.

FIG. 8 illustrates a schematic diagram of a method for computation across an attention layer and an MLP layer of a transformer-based neural network in accordance with another exemplary embodiment of the disclosure.

To make the above features and advantages of the application more comprehensible, several embodiments accompanied with drawings are described in detail as follows.

### DESCRIPTION OF THE EMBODIMENTS

To solve the prominent issue, some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

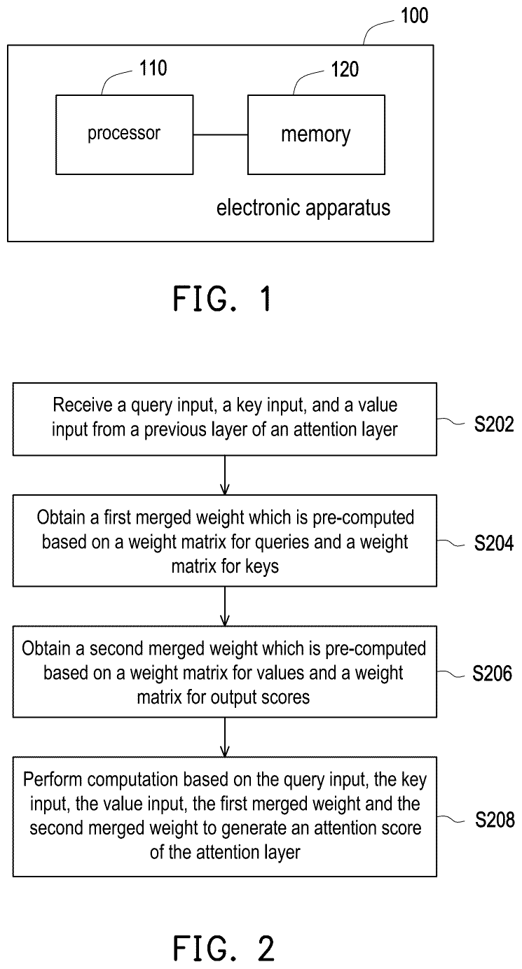

FIG. 1 illustrates a schematic diagram of an electronic apparatus in accordance with an exemplary embodiment of the disclosure. All components and configurations of the electronic apparatus are first introduced in FIG. 1. The functionalities of the components are explained in more details later on.

Referring to FIG. 1, an electronic apparatus 100 would at least include a processor 110 and a memory 120. The electronic apparatus 100 may be an electronic system or a computer system. The processor 110 would be configured to perform computation on a transformer-based neural network and may be one or more of a central processing unit (CPU), a graphic processing unit (GPU), an application processor (AP), a programmable general purpose or special purpose microprocessor, a digital signal processor (DSP), a field programmable array (FPGA), an application specific integrated circuit (ASIC), other similar devices, integrated circuits, or a combination thereof. The memory 120 would be configured to store data and may be many forms of random-access memory (RAM) such as a dynamic random-access memory (DRAM), other similar devices, integrated circuits, or a combination thereof.

FIG. 2 illustrates a flowchart of a method for computation on an attention layer of a transformer-based neural network in accordance with an exemplary embodiment of the disclosure, where the steps of FIG. 2 may be implemented by the electronic apparatus 100 as illustrated in FIG. 1.

Referring FIG. 2 in conjunction with FIG. 1, the processor 110 would receive a query input, a key input, and a value input from a previous layer of the attention layer (Step S202). Herein, the query input, the key input, and the value input may be features maps outputted from a convolutional layer of the neural network.

Next, the processor 110 would obtain a first merged weight which is pre-computed based on a weight matrix for queries and a weight matrix for keys (Step S204) and obtain a second merged weight which is pre-computed based on a weight matrix for values and a weight matrix for output scores (Step S206). In the present exemplary embodiment, the first merged weight and the second merged weight may be pre-computed offline and pre-stored in the memory 120 in order to reduce the number of parameters and the number of operations and thereby reducing online computation time, memory access amount, quantization error, and hardware resources. Thereafter, the processor 110 would perform computation based on the query input, the key input, the value input, the first merged weight and the second merged weight to generate an attention score of the attention layer (Step S208) such that the problem in the existing art would be resolved. More details would be presented comprehensively hereafter.

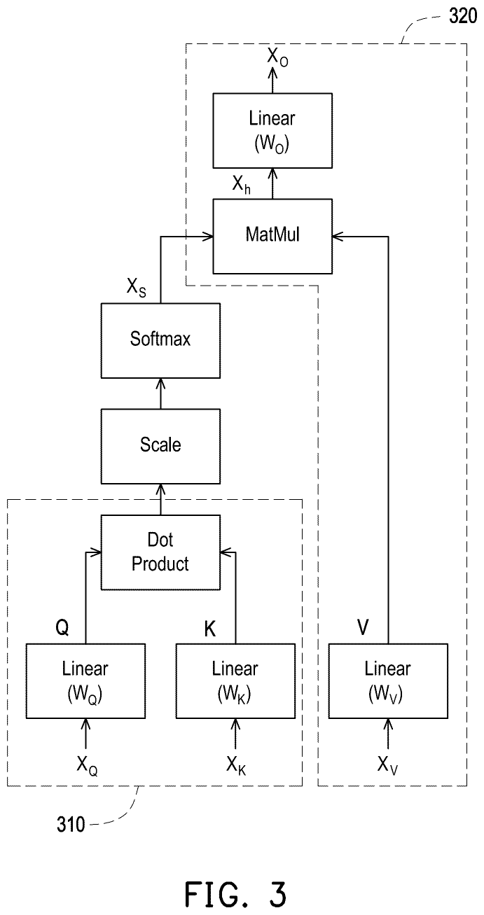

FIG. 3 illustrates a schematic diagram of a method for computation on an attention layer of a standard transformer-based neural network in the existing art.

Referring to FIG. 3, an attention weight X_{S} is computed by a dot product of a weighted query input Q (a query input X_{Q} subject to a linear weight W_{Q}) and a weighted key input K (a key input X_{K} subject to a linear weight W_{K}) followed by a scale operation and a softmax function. An attention score X_{O} is computed by a matrix multiplication of the attention matrix Xₕ and a weighted value input V (a value input X_{V} subject to a linear weight W_{V}) subject to a linear weight W_{O}.

The objective of the proposed method in the present exemplary embodiment is to manipulate operations in 310 and 320 in FIG. 3 through techniques of weight merging (referred to as “QK merging” and “VO merging” hereinafter respectively).

The dot product operation in 310 can be rewritten as a dot product Dot(Q,K), where Q=(X_{Q}W_{Q}) and K=(X_{K}W_{K}). The proposed QK merging would involve substitution, expansion, and merging, where the dot product can be further rewritten as the following Eq. (1):

$$\begin{matrix}Dot ( Q , K ) = ( {X}_{Q} {W}_{Q} ) {( {X}_{K} {W}_{K} )}^{T} \\ = {X}_{Q} ( {W}_{Q} {W}_{K}^{T} ) {X}_{K}^{T} \\ = {X}_{Q} {W}_{Q K} {X}_{K}^{T}\end{matrix}$$

Note that W_{QK} denotes the aforesaid first merged weight which is a multiplication of the weight matrix for queries W_{Q} and a transpose of the weight matrix for keys W_{K}^{T}.

The multiplication operation in 320 can be rewritten as X_{O}=X_{S} (X_{V}W_{V}) W_{O}, where V=(X_{V}W_{V}). The proposed VO merging would involve substitution and merging, where the multiplication operation can be further rewritten as the following Eq. (2):

$$\begin{matrix}{X}_{O} = {X}_{S} ( {X}_{V} {W}_{V} ) {W}_{O} \\ = {X}_{S} {X}_{V} ( {W}_{V} {W}_{O} ) \\ = {X}_{S} {X}_{V} {W}_{V O}\end{matrix}$$

Note that W_{VO} denotes the aforesaid second merged weight which is the weight matrix for values W_{V} and the weight matrix for output scores W_{O}.

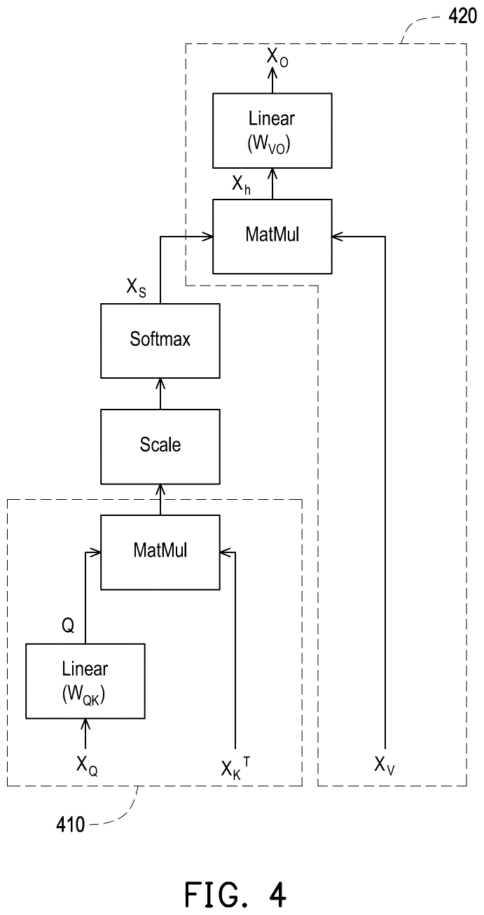

FIG. 4 illustrates a schematic diagram of a method for computation on an attention layer of a transformer-based neural network in accordance with an exemplary embodiment of the disclosure, where the operations of FIG. 4 may be implemented by the electronic apparatus 100 as illustrated in FIG. 1.

Referring to FIG. 4 in conjunction with FIG. 1, the processor 110 would obtain a first merged weight W_{QK} and a second merged weight W_{VO} pre-computed and pre-stored in the memory 120. Note that operations in 410 correspond to the QK merging derived in Eq. (1). The processing 110 would perform multiplication on a query input X_{Q}, the first merged weight W_{VO}, and a transpose of a key input X_{K}^{T} to generate a first multiplication result. Next, the processor 110 would perform computation on the first multiplication result to generate an attention weight X_{S}. For example, the processor 110 may perform a scale operation on the first multiplication result to generate a scaled multiplication result, and may further apply a softmax function on the scaled multiplication result to generate the attention weight X_{S}. Moreover, note that operations in 420 correspond to the VO merging derived in Eq. (2). The processing 110 would perform multiplication on the attention weight X_{S}, a value input X_{V}, and the second merged weight W_{VO} to generate an attention score X_{O} of the attention layer.

In terms of the performance, assume that the dimensions of X_{Q} and X_{K} are both N×D, the dimensions of W_{Q} and W_{K} are both D×d, the dimensions of Q and K are both N×d. The proposed technique may need only

$$\frac{ND ( D + N )}{Dd ( 2 d + N )}$$

of the number of operations compared to the existing art (i.e. less instructions are required). Intuitively speaking, assume that N=1024, D=384, and d=384. The proposed technique may reduce 62% of the number of parameters compared to the existing art (i.e. latency is shortened). Moreover, since the proposed technique is not an approximate approach, the accuracy is also guaranteed.

In another exemplary embodiment, to further reduce the number of parameters, the first merged weight may be pre-computed based on a low-rank decomposition of a weight matrix for queries and a low-rank decomposition of a weight matrix for keys. In detail, Eq. (1) may be further subject to low rank decomposition as presented in the following Eq. (3):

$$\begin{matrix}{X}_{Q} {W}_{Q} {W}_{K}^{T} {X}_{K}^{T} \\ = {X}_{Q} ( {U}_{Q} {S}_{Q} ) ( {U}_{K}^{T} {S}_{K}^{T} ) {X}_{K}^{T} \\ = {X}_{Q} ( {U}_{Q} {S}_{Q} {U}_{K}^{T} ) {S}_{K}^{T} {X}_{K}^{T} \\ = {X}_{Q} {U}_{Q}^{′} {S}_{K}^{T} {X}_{K}^{T}\end{matrix}$$

That is, the low-rank decomposition of the weight matrix for queries W_{Q} produces a first low-rank weight matrix for queries U_{Q} and a second low-rank weight matrix for queries S_{Q}, where the low-rank decomposition of the weight matrix for keys W_{K} produces a first low-rank weight matrix for keys U_{K} and a second low-rank weight matrix for keys S_{K}. The first merged weight in this case would then be a multiplication of a first merged low-rank weight U_{Q}′ and the transpose of the first low-rank weight matrix for keys S_{K}^{T}, where the first low-rank merged weight U_{Q}′ is a multiplication of the first low-rank weight matrix for queries U_{Q}, the second low-rank weight matrix for queries S_{Q}, and the transpose of the first low-rank weight matrix for keys U_{K}^{T}.

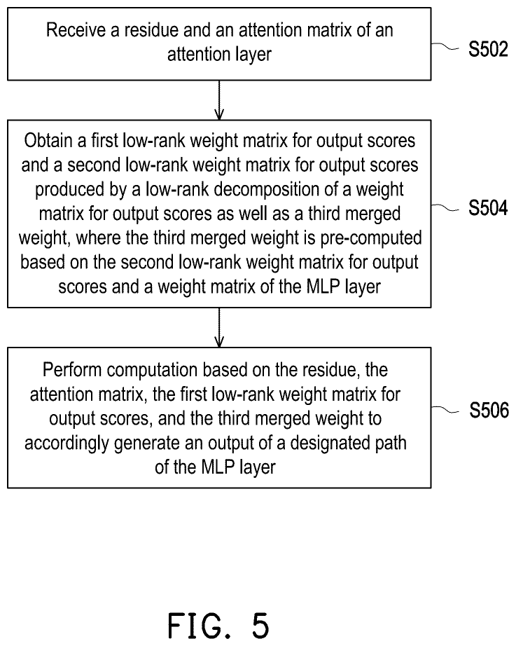

The weight merging mechanism may also be applied to a layer other than the attention layer of a transformer-based neural network. For example, FIG. 5 illustrates a flowchart of a method for computation across an attention layer and an MLP layer of a transformer-based neural network in accordance with an exemplary embodiment of the disclosure, where the steps of FIG. 2 may be also implemented by the electronic apparatus 100 as illustrated in FIG. 1.

Referring to FIG. 5 in conjunction with FIG. 1, the processor 120 would receive a residue and an attention matrix of an attention layer (Step S502).

The processor 120 would obtain a first low-rank weight matrix for output scores and a second low-rank weight matrix for output scores produced by a low-rank decomposition of a weight matrix for output scores as well as a third merged weight, where the third merged weight is pre-computed based on the second low-rank weight matrix for output scores and a weight matrix of the MLP layer (Step S504). In the present exemplary embodiment, the third merged weight may be pre-computed offline and pre-stored in the memory 120 in order to reduce the number of parameters and the number of operations as well. The processor 120 would perform computation based on the residue, the attention matrix, the first low-rank weight matrix for output scores, and the third merged weight to accordingly generate an output of a designated path of the MLP layer (Step S506). Herein, the designated path is a path across the attention layer and the MLP layer. More details would be presented comprehensively hereafter.

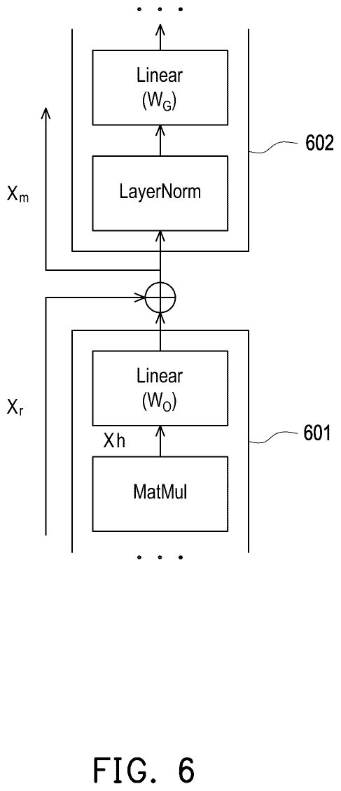

FIG. 6 illustrates a schematic diagram of a method for computation across an attention layer and an MLP layer of a standard transformer-based neural network in the existing art.

Referring to FIG. 6, a residue Xᵣ is added to an attention score of an attention layer 601 to produce an additive result, where the attention score is a multiplication of an attention weight Xₕ and a weight matrix for output scores W_{O}. The additive result is split into two paths: high frequency signals of the additive result would be inputted into an MLP layer 602 to perform layer normalization and subject to a linear weight W_{G}, and low frequency signals of the additive result (i.e. Xₘ) would be directly outputted.

The objective of the proposed method is to manipulate operations performed in a path across the two layers through techniques of weight merging (referred to as “SOG merging”). Moreover, layer normalization is a linear transformation and its computation may be delayed (i.e. computed after the weight operation).

The proposed SOG merging would involve inverse operation, low rank decomposition, and merging, where the operations across the two layers from the can be written as the following Eq. (4):

$$\begin{matrix}{X}_{g} = ( {X}_{r} + {X}_{h} {W}_{O} ) {W}_{G} \\ = ( {{X}_{r} ( {W}_{O} )}^{- 1} + {X}_{h} ) {W}_{O} {W}_{G} \\ = ( {{X}_{r} ( {U}_{O} {S}_{O} )}^{- 1} + {X}_{h} ) {U}_{O} {S}_{O} {W}_{G} \\ = ( {{X}_{r} ( {U}_{O} {S}_{O} )}^{- 1} + {X}_{h} ) {U}_{O} {W}_{S O G}\end{matrix}$$

Herein, X_{g} denotes the output of the designated path of the MLP layer, and W_{SOG} denotes the aforesaid third merged weight matrix which is multiplication of the second low-rank weight matrix for output scores S_{O} and the weight matrix W_{G} of the MLP layer.

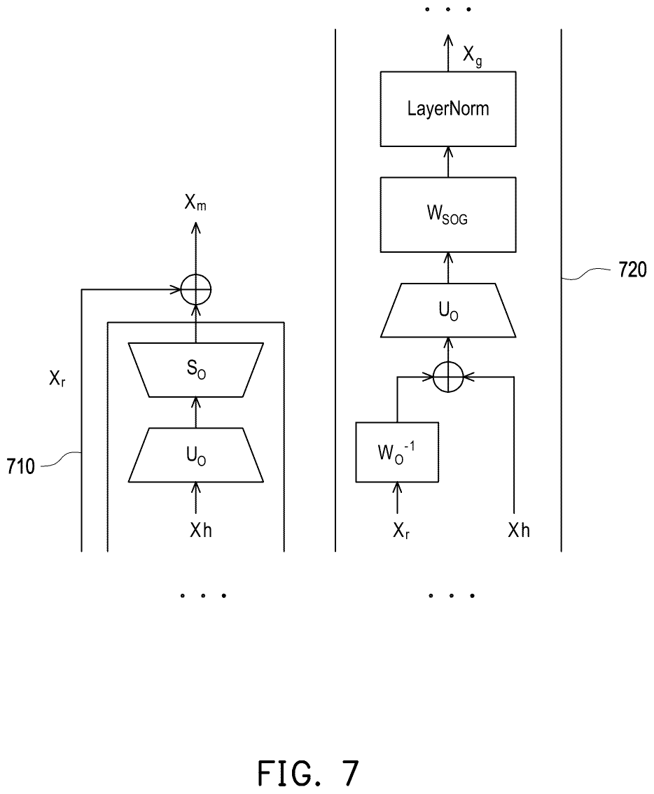

FIG. 7 illustrates a schematic diagram of a method for computation across an attention layer and an MLP layer of a transformer-based neural network in accordance with an exemplary embodiment of the disclosure, where the operations of FIG. 7 may be implemented by the electronic apparatus 100 as illustrated in FIG. 1.

Referring to FIG. 7 in conjunction of FIG. 1, the processor 110 would obtain a first low-rank weight matrix for output scores U_{O}, a second low-rank weight matrix for output scores S_{O}, the inverse of the multiplication of the first low-rank weight matrix for output scores and the second low-rank weight matrix for output scores (U_{O}S_{O})⁻¹, and the third merged weight W_{SOG} from the memory 120. As a side note, (U_{O}S_{O})⁻¹ may also be substituted by (W_{O})⁻¹ due to double precision operation.

In a path 710, which does not route into the MLP layer, the processor 110 would sum the residue Xr and the multiplication of the attention matrix Xₕ, the first low-rank weight matrix for output scores U_{O}, and the second low-rank weight matrix for output scores S_{O} to generate an output Xₘ of the path 710 of the MLP layer. The operations may be also represented by the following Eq. (5):

$${X}_{m} = {X}_{r} + {X}_{h} {U}_{O} {S}_{O}$$

In a second path 720, which route across the attention layer and the MLP layer, the processor 110 would sum the attention matrix Xₕ and the multiplication of the residue Xₕ and the inverse of the multiplication of the first low-rank weight matrix for output scores and the second low-rank weight matrix for output scores (U_{O}S_{O})⁻¹ to generate a first intermediate result. The processor 110 would next perform multiplication on the first intermediate result, the first low-rank weight matrix for output scores U_{O}, and the third merged weight W_{SOG} to generate a second intermediate result. The processor 110 would next apply layer normalization on the second intermediate result to generate an output X_{g} of the path 720 of the MLP layer.

In terms of the performance, assume that the dimensions of U_{O} and S_{O} are respectively D×r and r×D, the dimension of W_{O}⁻¹ is 2(D×D), and the dimension of W_{SOG} is r×8D.

$$\frac{2 {D}^{2} + 9 Dr}{2 Dr + 8 {D}^{2}}$$

of the number of operations compared to the existing art is required by using the proposed method. Intuitively speaking, assume that the rank r=D/4, 62% of the number of parameters compared to the existing art can be reduced by using the proposed method.

As a more aggressive merging approach, Eq. (4) may be further subject to an additional merge as presented in the following Eq. (6):

$$\begin{matrix}{X}_{g} = ( {{X}_{r} ( {U}_{O} {S}_{O} )}^{- 1} + {X}_{h} ) {U}_{O} {W}_{S O G} \\ = ( {{X}_{r} ( {U}_{O} {S}_{O} )}^{- 1} {U}_{O} + {X}_{h} {U}_{O} ) {W}_{S O G} \\ = ( {X}_{r} {W}_{O U} + {X}_{h} {U}_{O} ) {W}_{S O G}\end{matrix}$$

Herein, W_{OU} denotes a fourth merged weight which is the inverse of the multiplication of the first low-rank weight matrix for output scores and the second low-rank weight matrix for output scores (U_{O}S_{O})⁻¹ and the first low-rank weight matrix for output scores U_{O}.

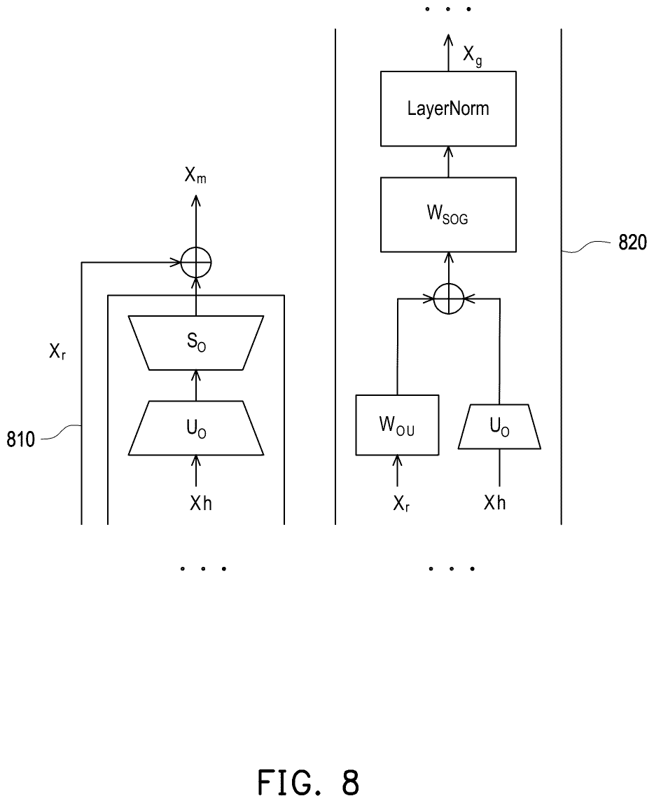

FIG. 8 illustrates a schematic diagram of a method for computation across an attention layer and an MLP layer of a transformer-based neural network in accordance with another exemplary embodiment of the disclosure, where the operations of FIG. 8 may be implemented by the electronic apparatus 100 as illustrated in FIG. 1.

Referring to FIG. 8 in conjunction of FIG. 1, the processor 110 would obtain the first low-rank weight matrix for output scores U_{O}, the second low-rank weight matrix for output scores S_{O}, the third merged weight W_{SOG}, and the fourth merged weight W_{OU} from the memory 120.

In a path 810, which does not route into the MLP layer, the processor 110 would sum the residue Xr and the multiplication of the attention matrix Xₕ, the first low-rank weight matrix for output scores U_{O}, and the second low-rank weight matrix for output scores S_{O} to generate the output Xₘ of the path 810 the MLP layer.

In a path 820, which route across the attention layer and the MLP layer, the processor 110 would sum a multiplication of the residue Xᵣ and the fourth merged weight W_{OU} and a multiplication of the attention matrix Xₕ and the first low-rank weight matrix for output scores U_{O} to generate a first intermediate result.

The processor 110 would next perform multiplication on the first intermediate result and the third merged weight W_{SOG} to generate a second intermediate result. The processor 110 applying layer normalization on the second intermediate result to generate the output of the first path of the MLP layer to generate an output X_{g} of path 820 of the MLP layer.

In terms of the performance, assume that the dimensions of U_{O} and S_{O} are respectively D×r and r×D, the dimension of W_{OU} is 2(D×r), and the dimension of W_{SOG} is r×8D.

$$\frac{13 D r}{2 D r + 8 {D}^{2}}$$

of the number of operations in the existing art is required by using the proposed method. Intuitively speaking, assume that the rank r=D/4, 62% of the number of parameters in the existing art can be reduced by using the proposed method.

In view of the aforementioned descriptions, various effective approaches proposed for computation on a transformer-based neural network so as to reduce online computation time, memory access amount, quantization error, and resource consumption with accuracy assurance.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for computation on an attention layer of a transformer-based neural network comprising:
receiving a query input, a key input, and a value input from a previous layer of the attention layer;
obtaining a first merged weight which is pre-computed based on a weight matrix for queries and a weight matrix for keys;
obtaining a second merged weight which is pre-computed based on a weight matrix for values and a weight matrix for output scores; and
performing computation based on the query input, the key input, the value input, the first merged weight and the second merged weight to generate an attention score of the attention layer.

2. The method according to claim 1, wherein the first merged weight is a multiplication of the weight matrix for queries and a transpose of the weight matrix for keys.

3. The method according to claim 1, wherein the second merged weight is a multiplication of the weight matrix for values and the weight matrix for output scores.

4. The method according to claim 1, wherein the step of performing computation based on the query input, the key input, the value input, the first merged weight and the second merged weight to generate the attention score of the attention layer comprises:
performing multiplication on the query input, the first merged weight, and a transpose of the key input to generate a first multiplication result;
performing computation on the first multiplication result to generate an attention weight; and
performing matrix multiplication on the attention weight, the value input, and the second merged weight to generate the attention score of the attention layer.

5. The method according to claim 4, wherein the step of performing computation on the multiplication result to generate the attention weight comprises:
performing scaling on the multiplication result to generate a scaled multiplication result; and
applying a softmax function on the multiplication result to generate the attention weight.

6. The method according to claim 1, wherein the first merged weight is pre-computed based on a low-rank decomposition of a weight matrix for queries and a low-rank decomposition of a weight matrix for keys.

7. The method according to claim 6, wherein the low-rank decomposition of the weight matrix for queries produces a first low-rank weight matrix for queries and a second low-rank weight matrix for queries, wherein a transpose of the low-rank decomposition of the weight matrix for keys produces a transpose of a first low-rank weight matrix for keys and a transpose of a second low-rank weight matrix for keys, wherein the first merged weight is a multiplication of a first merged low-rank weight and the transpose of the first low-rank weight matrix for keys, and wherein the first merged low-rank weight is a multiplication of the first low-rank weight matrix for queries, the second low-rank weight matrix for queries, and the transpose of the first low-rank weight matrix for keys.

8. A method for computation across an attention layer and a multilayer perceptron (MLP) layer of a transformer-based neural network comprising:
receiving a residue and an attention matrix of the attention layer;
obtaining a first low-rank weight matrix for output scores and a second low-rank weight matrix for output scores produced by a low-rank decomposition of a weight matrix for output scores as well as a third merged weight, wherein the third merged weight is pre-computed based on the second low-rank weight matrix for output scores and a weight matrix of the MLP layer; and
performing computation based on the residue, the attention matrix, the first low-rank weight matrix for output scores, and the third merged weight to accordingly generate an output of a designated path of the MLP layer.

9. The method according to claim 8, wherein the step of performing computation based on the residue, the attention matrix, the first low-rank weight matrix for output scores, and the third merged weight to accordingly generate the output of the designated path of the MLP layer comprises:
obtaining an inverse of the multiplication of the first low-rank weight matrix for output scores and the second low-rank weight matrix;
summing the attention matrix and a multiplication of the residue and the inverse of the multiplication of the first low-rank weight matrix for output scores and the second low-rank weight matrix to generate a first intermediate result;
performing multiplication on the first intermediate result, the first low-rank weight matrix for output scores, and the third merged weight to generate a second intermediate result; and
applying layer normalization on the second intermediate result to generate the output of the designated path of the MLP layer.

10. The method according to claim 8, wherein the step of performing computation based on the residue, the attention matrix, the first low-rank weight matrix for output scores, and the third merged weight to accordingly generate the output of the designated path of the MLP layer comprises:
obtaining a fourth merged weight which is pre-computed based on the first low-rank weight matrix for output scores and the inverse of the multiplication of the first low-rank weight matrix for output scores and the second low-rank weight matrix;
summing a multiplication of the residue and the fourth merged weight and a multiplication of the attention matrix and the first low-rank weight matrix for output scores to generate a first intermediate result;
performing multiplication on the first intermediate result and the third merged weight to generate a second intermediate result; and
applying layer normalization on the second intermediate result to generate the output of the designated path of the MLP layer.

11. The method according to claim 8 further comprising:
summing the residue and the multiplication of the attention matrix, the first low-rank weight matrix for output scores, and the second low-rank weight matrix for output scores to generate an output of another designated path of the MLP layer.

12. An apparatus for computation on an attention layer of a transformer-based neural network comprising:
a processor configured to:
receive a query input, a key input, and a value input from a previous layer of the attention layer;
obtain a first merged weight which is pre-computed based on a weight matrix for queries and a weight matrix for keys;
obtain a second merged weight which is pre-computed based on a weight matrix for values and a weight matrix for output scores; and
perform computation based on the query input, the key input, the value input, the first merged weight and the second merged weight to generate an attention score of the attention layer.

13. The apparatus according to claim 12 further comprising:
a memory, configured to pre-store the first merged weight.

14. An apparatus for computation across an attention layer and a multilayer perceptron (MLP) layer of a transformer-based neural network comprising:
a processor, configured to:
receive a residue and an attention matrix of the attention layer;
obtain a first low-rank weight matrix for output scores and a second low-rank weight matrix for output scores produced by a low-rank decomposition of a weight matrix for output scores as well as a third merged weight, wherein the third merged weight is pre-computed based on the second low-rank weight matrix for output scores and a weight matrix of the MLP layer; and
perform computation based on the residue, the attention matrix, the first low-rank weight matrix for output scores, and the third merged weight to accordingly generate an output of a designated path of the MLP layer.

15. The apparatus according to claim 14 further comprising:
a memory, configured to pre-store low-rank decomposition of a weight matrix for output scores comprising a first low-rank matrix for output scores and a second low-rank matrix for output scores, and a third merged weight.
